(19) United States
(12) Patent Application Publication
(10) Pub. No.: US 2024/0359216 A1
(43) Pub. Date: Oct. 31, 2024

(54) HEAVY MINERAL HARVESTING METHODS AND SYSTEMS

(71) Applicant: RADCAT RESEARCH, LLC, Zionsville, IN (US)

(72) Inventors: Theodore Casey MOORE, Zionsville, IN (US); Aidan Trefor MOORE, Zionsville, IN (US); Connor Dylan MOORE, Zionsville, IN (US); Rhianna Deirdre MOORE, Zionsville, IN (US)

(73) Assignee: RADCAT RESEARCH, LLC, Zionsville, IN (US)

(21) Appl. No.: 18/766,074

(22) Filed: Jul. 8, 2024

Related U.S. Application Data
(63) Continuation-in-part of application No. PCT/US2023/060069, filed on Jan. 4, 2023.
(60) Provisional application No. 63/297,122, filed on Jan. 6, 2022.

(51) Int. Cl. B07B 13/11

(52) U.S. Cl. CPC B07B 13/113

(57) ABSTRACT

A method for harvesting heavy mineral from a regolith may comprise: flowing a layer of particulate feedstock over a distribution chute having an uneven surface texture, the particulate feedstock comprising first particulates and second particulates that differ by at least one property; changing a momentum of individual particulates in the particulate feedstock while flowing over the distribution chute and/or after leaving the distribution chute such that the first particulates and the second particulates, on average, travel different lateral distances from the distribution chute; and collecting the particulate feedstock in a plurality of bins, wherein at least two of the bins are laterally spaced differently from the distribution chute.

### CROSS-REFERENCE TO RELATED APPLICATION(S)

The present application is a Continuation-in-Part of International Patent Application No. PCT/US2023/060069, filed Jan. 4, 2023, which claims priority to U.S. Provisional Application No. 63/297,122 filed Jan. 6, 2022, the entire content of each of which is hereby incorporated by reference herein.

### FIELD OF INVENTION

The present disclosure relates to heavy mineral harvesting methods and systems.

### BACKGROUND

Mineral sands are particulate mixtures of heavy mineral particulates like zircon, ilmenite, rutile, monazite, and gold and less dense mineral particulates like quartz. Traditionally, the heavy mineral particulates are extracted by using differences in properties (e.g., specific gravity, magnetic properties, and/or electrical properties) between the heavy mineral particulates and the less dense mineral particulates. Specific gravity is the most commonly used property.

Dredging is the most common method of separating the heavy mineral particulates from mineral sands. Typically, a pond or other water feature is created where a slurry of mineral sands in water is stored. Over time, the higher specific gravity, heavy mineral particulates settle more quickly than the less dense mineral particulates. Then, a dredging apparatus can be used to excavate the bottom layer in the pond, which is enriched with heavy mineral particulates. This process may be repeated several times to further enrich the final product with heavy mineral particulates. This process uses large quantities of water and large areas of land.

Other methods like magnetic separation and electrostatic separation have been considered for separating heavy mineral particulates from mineral sands. However, the availability of said methods depends on how well the particulate components in the mineral sands can be differentiated by said properties. Further, the throughput of said methods has been low. Accordingly, said methods have not integrated into industrial mining to a great extent.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 illustrates a nonlimiting example system of the present disclosure.

FIGS. 2A, 2B and 2C illustrate different configurations for the distribution chute.

FIG. 3 illustrates a measurement of an angle of a point of a surface of a distribution chute.

FIGS. 4A and 4B (zoom in of FIG. 4A) illustrate a nonlimiting example system of the present disclosure.

FIG. 4C is a schematic view of a nonlimiting example system of the present disclosure illustrating a plurality of movable bins including a central bin disposed radially inward of a distribution chute.

FIG. 5 illustrates a nonlimiting example of a portable system of the present disclosure.

FIG. 6 illustrates an experimental system for separating a particulate feedstock according to the methods described herein.

FIG. 7 illustrates a plot of the % mass of the particulate material collected in a bin as a function of the distance of the bin from the center of the distribution chute.

FIG. 8 is a top-view photograph of a surface texture (specifically corrugation) applied to the distribution chute and particulate matter passing thereover.

### DETAILED DESCRIPTION

The present disclosure relates to methods and systems for harvesting heavy mineral from a regolith. More specifically, the present disclosure describes waterless methods and systems for harvesting heavy mineral from a regolith. As used herein, the term “regolith” refers to uncoordinated material of planetary bodies. A regolith is typically a superficial deposit covering solid rock and encompasses dust, sand (e.g., mineral sand), broken rock, other related materials, and any combination thereof.

Generally, the methods and systems described herein use particulate flow and at least one momentum change to separate particulates having different properties (e.g., specific gravity, size, shape, magnetic properties, electrical properties, the like, and any combination thereof). That is, particulate feedstock is flowed in a specific direction where a stimulus is applied that may cause a change in momentum to individual particles. The degree of that momentum change may depend on the properties of the properties of each individual particle. The momentum change causes the different types of particulates to travel different lateral distances. Then, bins placed at different lateral distances to collect different portions of the particulate feedstock. Because in mineral sands, the particulate size and density for sand particulates versus the highly valued, heavy mineral particulates is substantially different. Some bins may collect material that is enriched with the heavy mineral particulates. The process may be repeated several times to further enrich the concentration of heavy mineral particulates.

The stimulus applied to the particulate feedstock includes impinging with gas, acoustic waves, and the like. The methods and systems described herein do not use water for separating the different particulates in the particulate feedstock. Therefore, the significant water requirements and associate water disposal issues with traditional mineral sands mining may be eliminated. Further, not needing vast quantities of water in the mineral sands mining process eliminates a significant hurdle for extraterrestrial mining endeavors. That is, with traditional mineral sands mining technologies, not only would equipment need to be transported to the extraterrestrial site, but also vast quantities of water since water is not naturally found in extraterrestrial sites like the moon, Mars, and asteroids. In contrast, the systems and methods described herein may only need equipment transportation.

Further, the systems described may be portable, which when compared to stationary ponds in tradition mineral sands mining, may allow for less land requirements at a mineral sands mining facility.

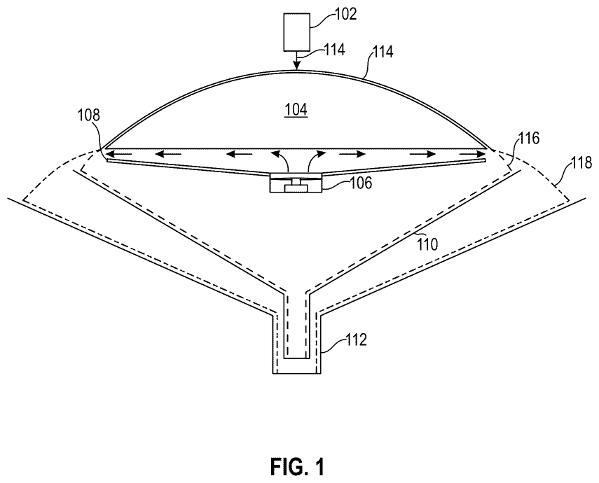

FIG. 1 illustrates a nonlimiting example system 100 of the present disclosure. The illustrated system includes: a hopper 102, a distribution chute 104, a fan 106, a gas stream outlet 108, a first bin 110, and a second bin 112. The hopper 102 is positioned above the distribution chute 104 and gravity feeds particulate feedstock 114 to the distribution chute 104. As the particulate feedstock 114 lands on and passes over (or cascades down) the distribution chute 104, the particulate feedstock 114 forms a layer of the particulate feedstock 114 that is thicker near the hopper and are more widely distributed in a thinner layer closer to the bottom edges of the distribution chute 104. The layer is not necessarily contiguous down and/or around the distribution chute 104. Within about the bottom 5 cm of the distribution chute 104 before the particulate feedstock 114 leaves the distribution chute 104, the particulate feedstock 114 is preferably a thin stream (or layer or cascade) having a thickness of about 5 particulates or less (or about 1 particulate to about 5 particulates, or about 1 particulate to about 3 particulates, or about 1 particulate to about 2 particulates, or about 1 particulate).

As the particulate feedstock 114 leaves the distribution chute 104, a gas stream exiting the gas stream outlet 108 impinges the particulate feedstock 114. The gas stream is moving non-parallel to the direction the particulate feedstock 114 is flowing. The gas stream applies momentum to the particulate feedstock 114. The amount of momentum for each particulate depends on, among other things, the size, shape, and specific gravity of the particulate. The amount of momentum may push the individual particles outward from the flow path of the particulate feedstock flow path. Because the amount of momentum is different, separate particulate streams having different lateral distances from the distribution chute 104 may emerge, illustrated as a first particulate stream 116 that travels first lateral distance 120 and a second particulate stream 118 that travels second lateral distance 122. In the illustrated example, higher specific gravity particles and/or smaller particles may be primarily in the second particulate stream 118, and lower specific gravity and/or larger particles may be primarily in the first particulate stream 116.

The system 100 further includes a plurality of bins, illustrated as first bin 110 and second bin 112, configured to collect particulates that travel different distances from the distribution chute 104.

FIG. 1 illustrates a nonlimiting example system 100 of the present disclosure. More generally, systems of the present disclosure include a momentum application feature (e.g., the gas stream of FIG. 1) that changes the momentum of particulates in the particulate feedstock such that at least two particulates of the particulate feedstock travel, on average, different lateral distances from the distribution chute before being collected in a bin. The momentum changing feature may be a feature (e.g., gas stream outlets) that causes a gas stream to impinge the particulate feedstock, a feature that causes an acoustic wave to impinge the particulate feedstock, a feature that causes vibrations to impinge the particulate feedstock, a feature that applies a magnetic field to the feedstock, a feature that applies an electrostatic charge to the particulate feedstock, a feature that applies radiation pressure to the particulate feedstock, a feature that applies a rotation to the particulate feedstock, a feature that applies a translation to the particulate feedstock, the like, and any combination thereof. The feature causes a change in the moment of individual particulates based on differences in, for example, specific gravity, size, shape, magnetic properties of the particulates, electrical properties of the particulates, the like, and any combination thereof.

Accordingly, a system of the present disclosure may comprise: a hopper capable of feeding a particulate feedstock to a distribution chute; the distribution chute capable of dispersing the particulate feedstock into a layer; a momentum changing feature capable of changing a momentum of individual particulates in the particulate feedstock such that first and second particulates of the particulate feedstock travel, on average, different lateral distances from the distribution chute, wherein the first and second particulates have at least one different property (e.g., specific gravity, size, shape, magnetic properties, electrical properties, the like, and any combination thereof); and a plurality of bins capable of collecting the particulate feedstock therein, wherein at least two of the bins are laterally spaced differently from the distribution chute.

Further, a method of the present disclosure may comprise: flowing a layer of particulate feedstock over a distribution chute, the particulate feedstock comprising first particulates and second particulates that differ by at least one property (e.g., specific gravity, size, shape, magnetic properties, electrical properties, the like, and any combination thereof); changing a momentum of individual particulates in the particulate feedstock (e.g., using a gas stream, vibration, acoustic wave, magnetic field, electrical field, the like, and any combination thereof) while flowing over the distribution chute and/or after leaving the distribution chute such that the first particulates and the second particulates, on average, travel different lateral distances from the distribution chute; and collecting the particulate feedstock in a plurality of bins, wherein at least two of the bins are laterally spaced differently from the distribution chute.

The particulate feedstock may be sourced from mineral sands and comprise sand particulates and heavy mineral particulates. Generally, within a particulate feedstock, the sand particulates may have a lower specific gravity than the mineral particulates. The particulate feedstock may be sourced from previously separated particulate feedstock. For example, one or more bins may be used as particulate feedstock for further separation of the particulates therein.

Sand particulates may have a specific gravity of about 2 to about 4 (or about 2 to about 3, or about 2.5 to about 3.5, or about 3 to about 4). Sand particulates may be non-metal minerals like silicate, aluminosilicate, borosilicates, aluminoborosilicate, borate, aluminates, aluminoborates, and the like. Examples of sand particulates may include, but are not limited to, quartz, gypsum, the like, and any combination thereof.

Heavy mineral particulates may have a specific gravity of about 3.5 to about 7 (or about 3.5 to about 6, or about 4 to about 6.5, or about 5 to about 7). Heavy mineral particulates may include one or more minerals that comprise one or more transition metals, lanthanides, actinides, post-transition metals, and any combination thereof. Herein, aluminum is considered a nonmetal. For example, heavy mineral particulates may include one or more minerals that comprise one or more of: iron, zirconium, titanium, manganese, chromium, zinc, strontium, lanthanum, thallium, cerium, gadolinium, neodymium, samarium, prascodymium, the like, and any combination thereof. Examples of heavy mineral particulates may include, but are not limited to, zircon, garnet, ilmenite, rutile, leucoxene, staurolite, celestine, monazite, magnetite, chromite, kyanite, hornblende, olivine, sphene, the like, and any combination thereof.

Depending on the regolith, the sand particulates and the heavy mineral particulates may be of similar average diameter (e.g., within about 5% of each other) or may be different. As used herein, unless otherwise specified, average diameter refers to a weight average diameter where diameter is the largest diameter of a particulate.

Sand particulates may have an average diameter of about 50 microns to about 2000 microns (or about 50 microns to about 500 microns, or about 200 microns to about 1000 microns, or about 600 microns to about 2000 microns).

Heavy mineral particulates may have an average diameter of about 50 microns to about 2000 microns (or about 50 microns to about 500 microns, or about 200 microns to about 1000 microns, or about 600 microns to about 2000 microns).

For example, particulate feedstocks may have different diameters for sand particulates and heavy metal particulates. For example, the sand particulates (cumulatively measured for all types of sand particulates in said feedstock) have an average diameter by weight of about 200 microns to about 1000 microns, and the heavy mineral particulates (cumulatively measured for all types of heavy mineral particulates in said feedstock) may have an average diameter by weight of about 50 microns to about 250 microns. As appreciated by those skilled in the art, diameter by weight is a measure of the mean diameter by weight of mixture.

The particulate feedstocks may have a different surface roughness and/or morphology for sand particulates and heavy metal particulates. Generally, heavy metal particulates may be more jagged, facetted, and/or crystalline, whereas sand particulates may be smoother and/or amorphous like weathered rock. Accordingly, the momentum changing feature may take advantage of the flow characteristic differences of sand particulates and heavy metal particulates that are derived, at least in part, from the surface roughness and/or morphology of each of said particulates.

The particulate feedstocks may have a tribology for sand particulates and heavy metal particulates where the momentum changing feature may take advantage of each particulates ability to hold and transfer charge upon contact with particles in the particulate feedstocks and/or various surfaces.

As described previously, the particulate feedstock may be sourced from previously separated particulate feedstock. For example, one or more bins may be used as particulate feedstock for further separation of the particulates therein. This may allow for further purification to the desired particulates (e.g., sand particulates in general, one or more specific sand particulates, heavy mineral particulates in general, or one or more specific heavy mineral particulates). By way of nonlimiting example, the particulate feedstock may be from a previous separation and be primarily (e.g., 51 wt % or greater, or 60 wt % or greater, or 75 wt % or greater, or 90 wt % or greater) heavy mineral particulates. Said particulate feedstock that is primarily heavy mineral particulates may be further separated using the methods and systems described herein to further remove sand and further purify to greater percentages of heavy mineral particulates. Alternatively or in addition to said purification, the particulate feedstock that is primarily heavy mineral particulates may be further separated using the methods and systems described herein to separate different heavy minerals. For example, if said particulate feedstock that is primarily heavy mineral particulates comprises zircon and ilmenite, the methods and systems described herein to separate the zircon and ilmenite (e.g., produce a bin with an enhanced zircon concentration and a bin with an enhanced ilmenite concentration each as compared to the feedstock before implantation of the method and/or system).

Particulate feedstock may be fed to the distribution chute at a rate of about 10 kg per hour to about 1,000 metric tons per hour (or about 10 kg per hour to about 500 kg per hour, or about 250 kg per hour to about 1 metric tons per hour, or about 0.5 metric tons per hour to about 10 metric tons per hour, or about 5 metric tons per hour to about 150 metric tons per hour, or about 100 metric tons per hour to about 500 metric tons per hour, or about 400 metric tons per hour to about 800 metric tons per hour, or about 750 metric tons per hour to about 1,000 metric tons per hour). The feed rate to the distribution chute may depend on the gravity present, where lower gravity may have lower feed rates. The feed rate may also depend on the size of the hopper and distribution chute, the configuration of the distribution chute, the method by which momentum of the particulates is being changed, and so on.

The distribution chute preferably causes the particulate feedstock to form a thin layer of particulates (e.g., about 10 mm thick or less, or about 5 mm thick or less, or about 1 mm thick or less, or about 1 particle thick to about 10 mm thick, or about 1 particle thick to about 5 mm thick, or about 1 particle thick to 1 mm thick) so that the momentum change is more effectively and uniformly applied to the particulates.

Generally, the distribution chute is shaped to have a smaller lateral width where the particulate feedstock is added and a larger lateral width where the particulate feedstock leaves the distribution chute. The distribution chute may have a radial configuration (e.g., conical or cycloid) or a longitudinal configuration (e.g., an elongated structure with a triangular cross-section like an inverted trough). In either configuration, the cross-section of the distribution chute (for the surface that contacts the particulate feed) may be a triangular, an inverted catenary, an inverted parabolic, the like, and any hybrid thereof. The distribution chute may be a single surface or a series of surfaces (e.g., stacked surfaces).

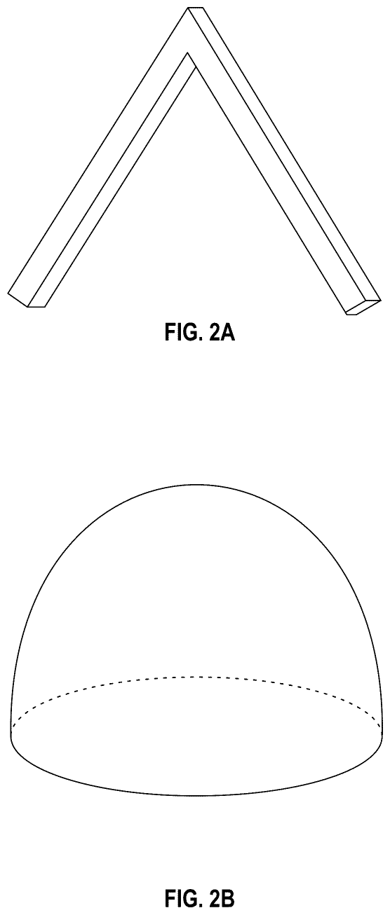

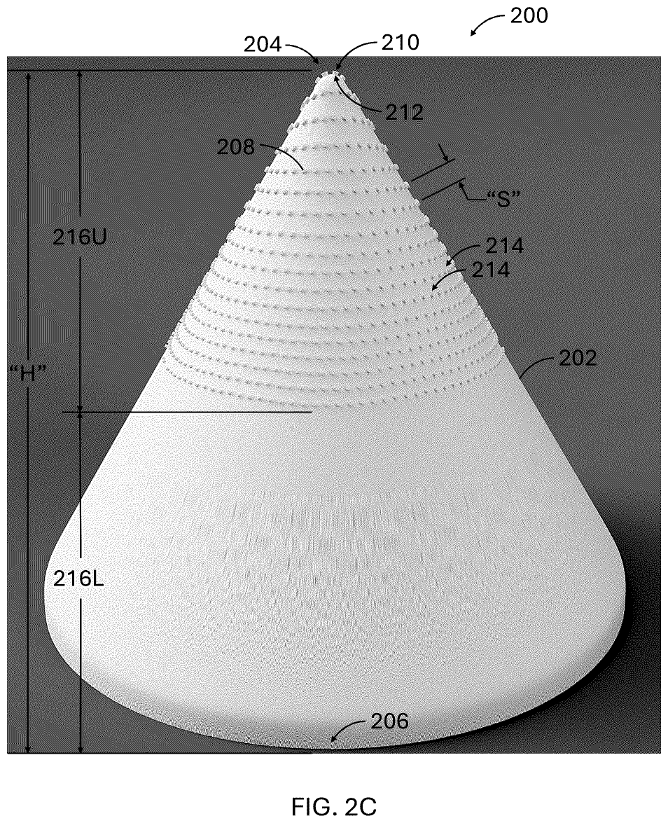

FIGS. 2A-2B illustrate different configurations for the distribution chute, where FIG. 2A illustrates a triangular cross-section in a longitudinal configuration, and FIG. 2B illustrates an inverted catenary shape with a radial configuration.

FIG. 2C illustrates another configuration for a distribution chute 200 with an angled surface 202. The angled surface 202 is arranged in a generally conical shape defining an apex 204 and a circular base 206. A particulate feedstock may be added to the distribution chute 200 at the apex 204, which has a smaller lateral width than a lateral width of the base 206 where the particulate feedstock may leave the distribution chute 200.

The distribution chute 200 defines an uneven surface texture. Specifically, the distribution chute 200 includes diversions from the angled surface 202 in the form of a plurality of discrete protrusions 208. In the illustrated embodiment, protrusions 208 extend generally orthogonally from the angled surface 202 and are in the shape of inverted truncated cones. Each of the protrusions 208 exhibit a relatively broad distal end 210 compared to a proximal end 212 where the protrusions 208 engage the angled surface 202. In some embodiments, the distal ends 212 may have a diameter of about 100 microns or less and may be spaced from the angled surface 202 by about 50 microns or less.

In the illustrated embodiment, the protrusions 208 are not evenly spaced over the angled surface 202. The protrusions 208 are arranged in circumferential rings 214 around an upper portion 216U of the angled surface 202 including the apex 204, while a lower portion 216L of the angled surface 202 including the base 206 is devoid of any protrusions 208. In some embodiments, the upper portion 216U including the protrusions 208 extends over only about a third to about a half of a vertical height “H” of the distribution chute 200. Additionally, the circumferential rings 214 are not evenly spaced from one another. A tangential spacing “S” between the circumferential rings 214 generally decreases in a downward direction from the apex 204 toward the lower portion 216. This arrangement of the protrusions 208 facilitates separation of a particulate feedstock added to distribution chute 200 at the apex 204 and changes a momentum of individual particles in the feedstock flowing over the angled surface 202 to ensure that particles of differing properties travel, on average, different lateral distances from the distribution chute 200 after leaving the distribution chute 200.

In other embodiments, the diversions from an angled or curved surface may take other forms. For instance, diversions may include protrusions in the form of upright cones or pylons, rectangular blocks, cylindrical bosses, circumferential bands extending around a distribution chute and other various shapes. In other embodiments, the diversions may include recesses, indentations or dimples extending inward from an angled surface. The diversions may also extend from or into the angled or curved surface in directions other than an orthogonal direction from the angled or curved surface.

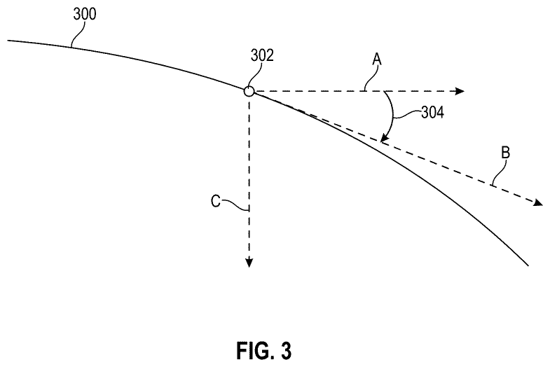

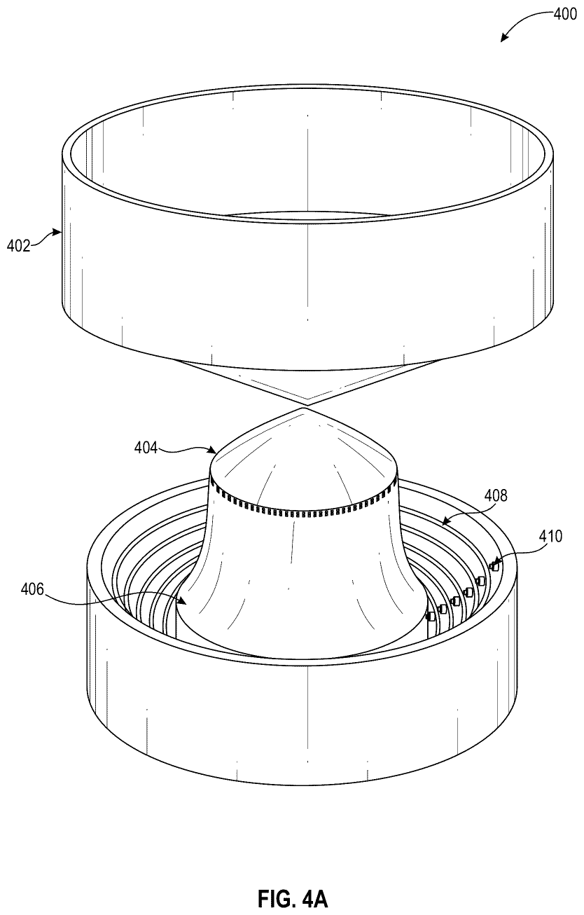

As the distribution chute transitions from where the particulate feedstock is added to where the particulate feedstock leaves the distribution chute, the surface of the distribution chute is preferably shaped to include angles that are greater than the angle of repose for the particulate feedstock at separation conditions and, more preferably, angles that are greater than the angle of repose for both of the sand particulates and heavy metal particulates at separation conditions. The angle of repose is a measure of the steepest angle of descent or dip relative to the horizontal plane to which a material can be piled without slumping. At angles greater than the angle of repose, particulates will flow. The angle of repose may depend on properties of the particles (e.g., surface roughness, morphology, composition, density, moisture or solvent fraction, and the like) as well as ambient conditions (e.g., humidity, temperature, and the like). Without being limited by theory, it is believed that particulate feedstocks and components thereof for the methods and systems described herein may have an angle of repose between about 30° and about 50°. Accordingly, to avoid pile-up of particulates on the distribution chute, the distribution chute from where the particulate feedstock is added to where the particulate feedstock leaves the distribution chute should have angles of about 30° or greater (or about 35° or greater, or about 40° or greater, or about 45° or greater, or about 30° to about 80°, or about 30° to about 60°, or about 35° to about) 50°. The angle for a point on the surface of the distribution chute is the angle between (a) a first vector extending from said point away from the surface and perpendicular to direction of gravity and (b) a second vector extending from the point that is either tangent to the surface for a curved surface or along the surface for a flat surface. FIG. 3 illustrates said angle 304 for a point 302 on a curved distribution chute surface 300 where the angle 304 is between (a) a first vector A extending from said point 302 away from the surface 302 and perpendicular to direction of gravity (vector C) and (b) a second vector B extending from the point 302 that is tangent to the curved surface 300.

The distribution chute may have a surface texture. The texture may be a uniform or non-uniform roughness and/or pattern along a surface of the distribution chute to which the particulate feed contacts. The texture may interact differently with particulates in the particulate feedstock based on chemical and/or physical properties of said particulates. Examples of such surface conditions may include, but are not limited to, friction, a surface's ability to store or dissipate electrical charge, other surface condition materially contributes to the dispersion of different types of particulates in the particulate feedstock, and any combination thereof. The surface conditions may interact to varying degrees with one or more of the particulates as said particulates travel along the distribution chute. For example, the degree of interaction between one or more of the particulates and the surface of the distribution chute may be nonlinear as said particulates travel along the distribution chute, which may affect the flow in both a temporal and spatial manner with respect to the surface conditions.

Preferably, the particulate feedstock is dry to facilitate proper flow on the distribution chute and proper separation. Dry particulate feedstock may mitigate agglomeration issues and allow for a proper thin layer of particulate feedstock to form on the distribution chute. The particulate feedstock preferably comprises about 5 wt % or less (or 0 wt % to about 5 wt %, or 0 wt % to about 3 wt %, or about 0.5 wt % to about 3 wt %, or about 2 wt % to about 5 wt %) water when contacting the distribution chute.

The particulate feedstock may be dried prior to and/or while in the hopper. Accordingly, systems described herein may optionally include a heater coupled to and/or upstream of the hopper.

The bins may be suitably shaped and spaced to collect portions of the particulate feedstock that travel different lateral distances from the distribution chute. The bins may be abutting with openings where each opening, independently, may have a lateral width of about 1 mm to about 100 cm (or about 1 mm to about 50 mm, or about 10 mm to about 250 mm, or about 100 mm to about 1 cm, or about 0.5 cm to about 10 cm, or about 1 cm to about 50 cm, or about 25 cm to about 75 cm, or about 50 cm to about 100 cm). For example, each opening may have a different lateral width. In another example, all openings may have the same lateral width. In another example, some openings may have the same lateral width while others have different lateral widths. The choice of lateral width for each opening may depend on the particulate feedstock throughput, distribution chute size, and/or other features implemented for separation (e.g., surface features, surface roughness, and others described herein), among other things. The lateral width for each opening may be according to a non-linear function (e.g., a logarithmic function). Further, the bins (or walls thereof) may be movable to provide different sizes of openings. Changing the size of one or more opening may occur on-the-fly while the system is operating and/or may occur during times when the system is not operating.

The bins may have any suitable spatial configuration. For example, with a radial configuration, the bins may be concentric, circular bins.

Further, the bins may have walls that are vertical and/or angled. For example, a wall of a bin may be vertical at the bottom and a top portion may be angled towards or away from the distribution chute. Alternatively, a wall of the bin may be exclusively vertical. Alternatively, a wall of the bin may be exclusively angled towards or away from the distribution chute. Each bin may have a desired configuration, which may or may not be a configuration of another bin in the system.

Any number of bins may be used. For example, 1 bin to 1,000 or more bins (or 1 bin to 100 bins, or 5 bins to 50 bins, or 25 bins to 250 bins, or 100 bins to 500 bins, or 250 bins to 1,000 bins or more) may be used in the systems and methods described herein.

One or more detectors may be coupled to one or more bins. The detectors may collect data relating to the compositions and/or properties of the particulates that entered the bins. For example, the detectors may be light scattering detectors that measure the particle size distribution of the particulate that enter the respective bin, capacitance measuring detectors, acoustic resonance detectors, liquid-displacement detectors, tuned electromagnetic resonance sensors, mass detection, and the like, and any combination thereof.

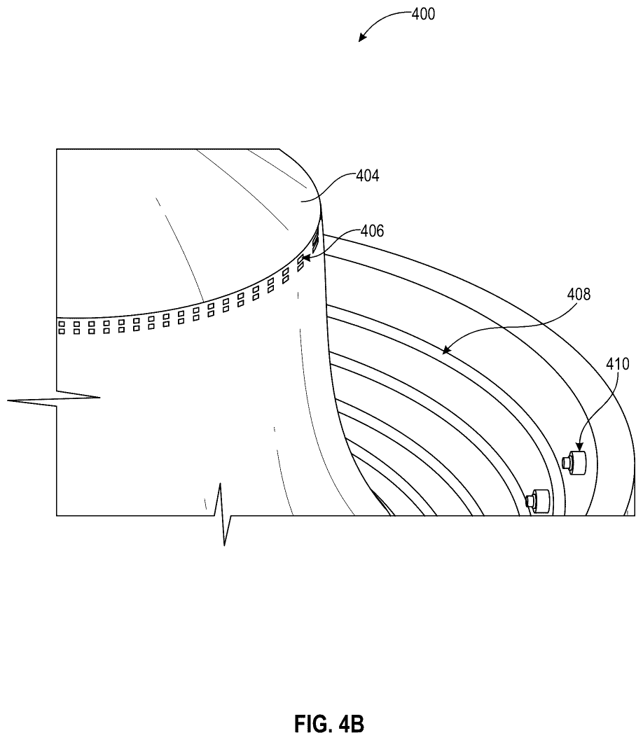

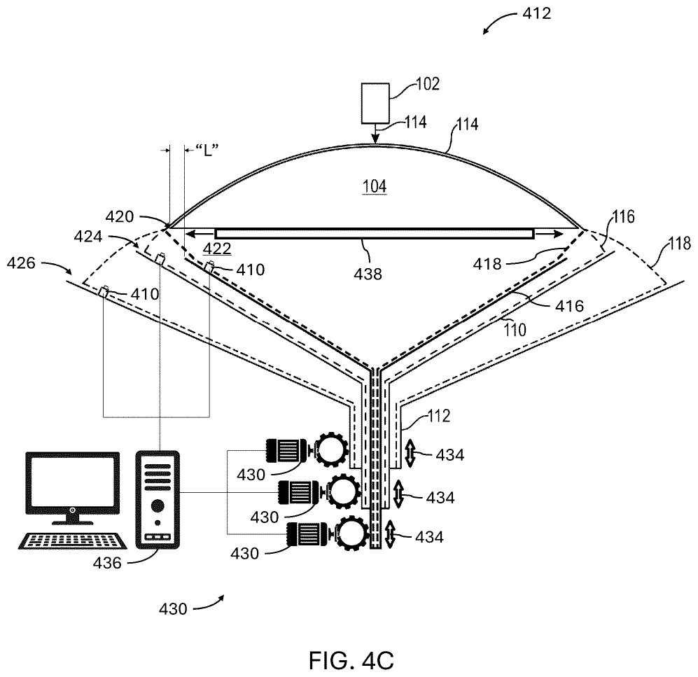

FIGS. 4A and 4B illustrate a nonlimiting example system 400 of the present disclosure that comprises a hopper 402, a distribution chute 404 (illustrated as a radial configuration having a hybrid triangular and inverted catenary shape), air vents 406 (e.g., gas stream outlets), concentric circular bins 408, and optional detectors 410 on each of the bins 408.

FIG. 4C illustrates another nonlimiting example system 412 of the present disclosure. The system 412 includes a hopper 102, a distribution chute 104, a first bin 110, and a second bin 112 as described above. A particulate feedstock 114 may be added to the distribution chute 104 from the hopper 102 and may be passed over a curved surface of the distribution chute 104 under the influence of gravity. The particulate feedstock 114 is separated into a first particulate stream 116 entering the first bin 110 and a second particulate stream 118 entering the second bin 112. The feedstock 114 may be separated by an uneven surface texture on the distribution chute 104 and/or a momentum changing feature 414 in a manner similar to the system 100 described above.

The system 412 also includes a central or third bin 416 for collecting a third particulate stream 418. The third particulate stream 418 may include particles following paths not dictated by simple parabolic projectile motion. For example, the particles frequently collide, leading to scattering and deviation from their expected projectile paths. Backscattering may occur, whereby the third particulate stream 418 may travel a lateral distance against the average flow of particulates leaving the distribution chute 104. Thus, the third collection bin 416 may be spaced by a lateral distance “L,” inward from an edge 420 of the distribution chute 104. In some embodiments, an opening 422 to the third bin 416 may be disposed entirely beneath the distribution chute 104.

The opening 422 and openings 424, 426 to the first and second bins 110, 112, respectively, may be adjusted by an adjustment mechanism 430. The adjustment mechanism 430 includes a plurality of electric motors 432, each operably coupled to a respective bin 110, 112, 416. The motors 432 are operable to independently move the bins 110, 112, 416 vertically in the direction of arrows 434. The movement of the bins 110, 112, 416 relative to the distribution chute 104 permits the size and the shape of the openings 422, 424, 426 to be adjusted in-situ, e.g., while the system 412 is in operation. The motors 432 may be communicatively coupled to a controller 436, which may be a computer-based system that may include a processor, a memory storage device, and programs and instructions, accessible to the processor for executing the instructions utilizing the data stored in the memory storage device. In other embodiments, the controller 436 may include manual controls that may be manipulated by an operator to control any of the procedures and equipment described herein. The controller 436 may also be communicatively coupled to detectors 410 in each of the bins 110, 112, 416. The detectors 410 may detect a parameter of the particulate streams 116, 118, 418, and transmit data signals indicative of the parameter to the controller 436. The controller 436 may compare the parameter to predetermined ranges to determine whether the bins 110, 112, 416 are in a desired position, or if adjustments are necessary. If the controller determines that adjustments are necessary, the controller 436 may transmit command signals to the motors 432 to implement the adjustments. In this manner, the adjustment mechanism 430 may accommodate changes to the particulate streams 116, 118, 418, and/or any unexpected dynamics observed in operation.

The momentum changing feature 438 may include a mechanism that does not rely on an atmosphere (or another supply of gas, liquid or other fluid) to apply a stimulus to the particulate feedstock. 114. For example, the momentum changing feature 438 may include a magnetic field generator, electrostatic charge generator, a radiation pressure generator, a motor or other mechanism to impart mechanical motion (e.g., vibrations, rotations, etc.) to the distribution chute 104. Where the momentum changing feature 438 is operable in a vacuum, the system 412 may facilitate mining operations in extraterrestrial environments such as the lunar surface or asteroids, for example.

Portions of the particulate feedstock collected from one or more bins may be enriched in one or more heavy mineral particulate compositions as compared to the particulate feedstock. The enrichment of heavy mineral particulates relative to the feedstock may be an increase of about 5 wt % to 90 wt % (or about 5 wt % to 25 wt %, or about 10 wt % to 50 wt %, or about 25 wt % to 60 wt %, or about 50 wt % to 80 wt %, or about 75 wt % to 90 wt %). That is, a particulate feedstock comprising 10 wt % of ilmenite separated according to the methods and systems described herein may have a bin (or combination of bins when combined) with a 20 wt % ilmenite (a 10 wt % increase in ilmenite). The enrichment may be for a single particulate composition or multiple particulates compositions cumulatively. For example, a particulate feedstock comprising 10 wt % heavy mineral particulates (e.g. comprising come combination of ilmenite, zircon, and monazite) separated according to the methods and systems described herein may have a bin (or combination of bins when combined) with a 30 wt % of the heavy mineral particulates (a 20 wt % increase in the heavy mineral particulates).

Once portions of the particulate feedstock are collected in the bins, the portions of particulate feedstock may be collected and/or transported to a suitable location. For example, portions of the particulate feedstock may be processed again for additional separation and enrichment of the heavy mineral particulates. In another example, portions of the particulate feedstock with low concentration of heavy mineral particulates may be considered tailings and treated as such. In another example, portions of the particulate feedstock with high concentration of heavy mineral particulates may be considered heavy mineral concentrations and treated as such.

Transportation of portions of the particulate feedstock may be facilitated with any suitable conveyance including, but not limited to, screws, helixes, pipes, conveyor belts, vehicles, the like, and any combination thereof.

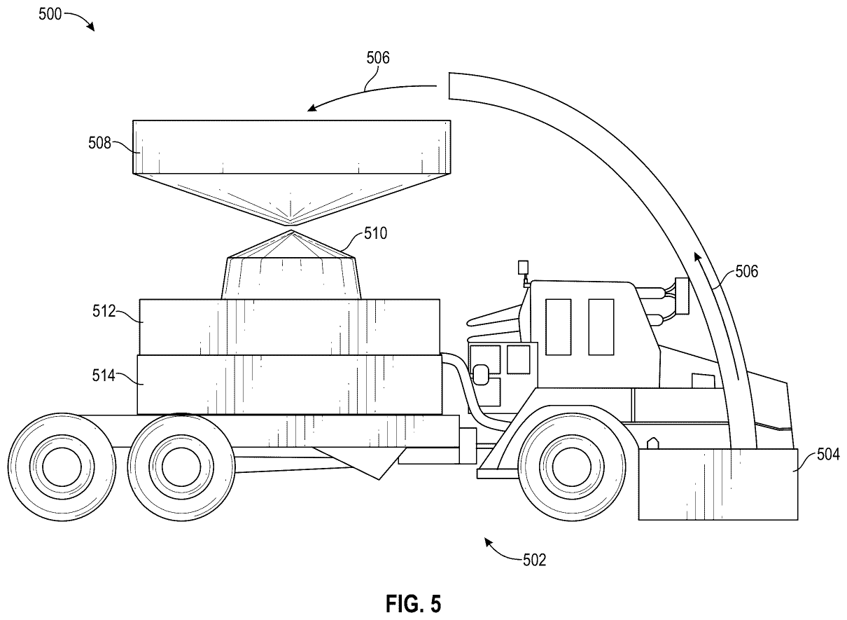

The systems described herein may be stationary systems that are built at a single location and particulate feedstock transported to the system. Alternatively, the systems described herein may be portable systems (e.g., on the back of a vehicle like an articulated truck) and movable to particulate feedstock locations. FIG. 5 illustrates a nonlimiting example of a portable system 500 that includes a truck 502 comprising a particulate feedstock collector and blower 504 capable of conveying the particulate feedstock (see arrows 506) to a hopper 508 mounted on the truck 502, a distribution chute 510 mounted on the truck 502, a plurality of concentric bins 514 mounted on the truck 502, and a particulate distribution system 514 mounted on the truck 502 that collects and/or transports particulate material in one or more of the bins 512 off the truck 520. Said mountings may be direct or indirect (e.g., the distribution chute 510 mounted to the bins 512 with the bins 512 directly mounted to the truck 502, or a housing containing the hopper 508, distribution chute 510, and/or 512 bins and the housing being directly mounted to the truck 502). Portions of the particulate distribution system 514 may connect to one or more pipes, conveyor belts, or the like for transporting the particulate material (based on its composition) to the next suitable location (e.g., a tailings dune, a heavy mineral concentrate storage location, another system for further enriching the heavy mineral particulates, and the like).

### EXAMPLE EMBODIMENTS

Clause 1. A method comprising: flowing a layer of particulate feedstock over a distribution chute, the particulate feedstock comprising first particulates and second particulates that differ by at least one property; changing a momentum of individual particulates in the particulate feedstock while flowing over the distribution chute and/or after leaving the distribution chute such that the first particulates and the second particulates, on average, travel different lateral distances from the distribution chute; and collecting the particulate feedstock in a plurality of bins, wherein at least two of the bins are laterally spaced differently from the distribution chute.

Clause 2. The method of Clause 1, wherein the layer has a thickness of about 10 mm or less.

Clause 3. The method of any of Clauses 1-2, wherein the at least one property comprises one or more of: specific gravity, size, shape, a magnetic property, and an electrical property.

Clause 4. The method of any of Clauses 1-3, wherein the first particulates are sand particulates and the second particulates are heavy mineral particulates.

Clause 5. The method of Clause 4, wherein the sand particulates comprise one or more minerals selected from the group consisting of: a silicate, an aluminosilicate, a borosilicate, an aluminoborosilicate, a borate, an aluminate, and an aluminoborate.

Clause 6. The method of any of Clauses 4-5, wherein the sand particulates comprise one or more minerals selected from the group consisting of: quartz and gypsum.

Clause 7. The method of any of Clauses 4-6, wherein the sand particulates have an average diameter by weight of about 200 microns to about 1000 microns.

Clause 8. The method of any of Clauses 4-7, wherein the heavy mineral particulates comprise one or more minerals selected from the group consisting of: zircon, garnet, ilmenite, rutile, leucoxene, staurolite, celestine, monazite, magnetite, chromite, kyanite, hornblende, olivine, and sphene.

Clause 9. The method of any of Clauses 4-8, wherein the heavy mineral particulates comprise one or more minerals that comprise one or more of: a transition metal, a lanthanide, an actinides, a post-transition metal.

Clause 10. The method of any of Clauses 4-9, wherein the heavy mineral particulates comprise one or more minerals that comprise one or more of: iron, zirconium, titanium, manganese, chromium, zinc, strontium, lanthanum, thallium, cerium, gadolinium, neodymium, samarium, and praseodymium.

Clause 11. The method of any of Clauses 4-10, wherein the heavy mineral particulates comprise one or more minerals having a specific gravity of about 3.5 to about 7, wherein the sand particulates comprise one or more minerals having a specific gravity of about 2 to about 4, and wherein a cumulative specific gravity less of the sand particulates is less than a cumulative specific gravity of the heavy mineral particulates.

Clause 12. The method of any of Clauses 4-11, wherein the heavy mineral particulates have an average diameter by weight of about 50 microns to about 250 microns.

Clause 13. The method of any of Clauses 1-12, wherein the applying of the momentum comprises: applying a gas stream to the layer at an angle not parallel to a flow direction of the particulate feedstock leaving the distribution chute.

Clause 14. The method of any of Clauses 1-13, wherein the applying of the momentum comprises: applying an acoustic wave to the layer at an angle not parallel to a flow direction of the particulate feedstock leaving the distribution chute.

Clause 15. The method of any of Clauses 1-14, wherein the applying of the momentum comprises: applying a vibration to the distribution chute.

Clause 16. The method of any of Clauses 1-15, wherein the applying of the momentum comprises: applying a magnetic field to the distribution chute.

Clause 17. The method of any of Clauses 1-16, wherein the applying of the momentum comprises: applying an electrostatic charge to the distribution chute.

Clause 18. The method of any of Clauses 1-17, wherein the applying of the momentum comprises: applying a radiation pressure to the distribution chute.

Clause 19. The method of any of Clauses 1-18, wherein the applying of the momentum comprises: applying a rotational movement to the distribution chute.

Clause 20. The method of any of Clauses 1-19, wherein the applying of the momentum comprises: applying a translational movement to the distribution chute.

Clause 21. The method of any of Clauses 1-20 further comprising: drying the particulate feedstock to less than about 5 wt % water before the flowing of the particulate feedstock over the distribution chute.

Clause 22. The method of any of Clauses 1-21, wherein the distribution chute has a cross-sectional shape comprising: a triangular shape, an inverted catenary shape, an inverted parabolic shape, or any hybrid thereof.

Clause 23. The method of any of Clauses 1-22, wherein the distribution chute comprises a series of surfaces.

Clause 24. The method of any of Clauses 1-23, wherein the distribution chute from where the particulate feedstock is added to where the particulate feedstock leaves the distribution chute has angles of about 30° or greater.

Clause 25. The method of any of Clauses 1-24, wherein the distribution chute has a surface texture.

Clause 26. The method of any of Clauses 1-25, wherein the distribution chute has a surface condition and/or a surface texture that is not uniform along the distribution chute.

Clause 27. The method of any of Clauses 1-26, wherein in a portion of particulate feedstock in at least one of the plurality of bins has a heavy mineral particulate enrichment of about 5 wt % to about 90 wt %.

Clause 28. The method of any of Clauses 1-27 further comprising: using the particulate feedstock in one or more of the plurality of bins as a second particulate feedstock and repeating the method of any of Clauses 1-27 with the second particulate feedstock.

Clause 29. A system comprising: a hopper capable of feeding a particulate feedstock to a distribution chute; the distribution chute capable of dispersing the particulate feedstock into a layer; a momentum changing feature capable of changing a momentum of individual particulates in the particulate feedstock such that first and second particulates of the particulate feedstock travel, on average, different lateral distances from the distribution chute, wherein the first and second particulates have at least one different property; and a plurality of bins capable of collecting the particulate feedstock therein, wherein at least two of the bins are laterally space differently from the distribution chute.

Clause 30. The system of Clause 29 further comprising: a dryer coupled to and/or upstream of the hopper.

Clause 31. The system of any of Clauses 29-30 further comprising: a sensor coupled to one or more of the plurality of bins.

Clause 32. The system of any of Clauses 29-31 further comprising: a vehicle having the hopper, the distribution chute, and the plurality of bins mounted thereto.

Clause 33. The system of Clause 32 further comprising: a particulate feedstock collector and blow mounted to the vehicle.

Clause 34. The system of any of Clauses 32-33 further comprising: a particulate distribution system mounted to the vehicle.

Clause 35. The system of any of Clauses 29-34, wherein the momentum changing feature includes one or more selected from the group consisting of: a feature that cause a gas stream to impinge the particulate feedstock, a feature that causes an acoustic wave to impinge the particulate feedstock, a feature that causes vibrations to impinge the particulate feedstock, a feature that applies a magnetic field to the feedstock, a feature that applies an electrostatic charge to the particulate feedstock, a feature that applies radiation pressure to the particulate feedstock, a feature that applies a rotation to the particulate feedstock, and a feature that applies a translation to the particulate feedstock.

Clause 36. The system of any of Clauses 29-35, wherein the distribution chute has a cross-sectional shape comprising: a triangular shape, an inverted catenary shape, an inverted parabolic shape, or any hybrid thereof.

Clause 37. The system of any of Clauses 29-36, wherein the distribution chute has a surface texture.

Clause 38. The system of any of Clauses 29-37, wherein the distribution chute has a surface condition and/or a surface texture that is not uniform along the distribution chute.

Unless otherwise indicated, all numbers expressing quantities of ingredients, properties such as molecular weight, reaction conditions, and so forth used in the present specification and associated claims are to be understood as being modified in all instances by the term ““about.”” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

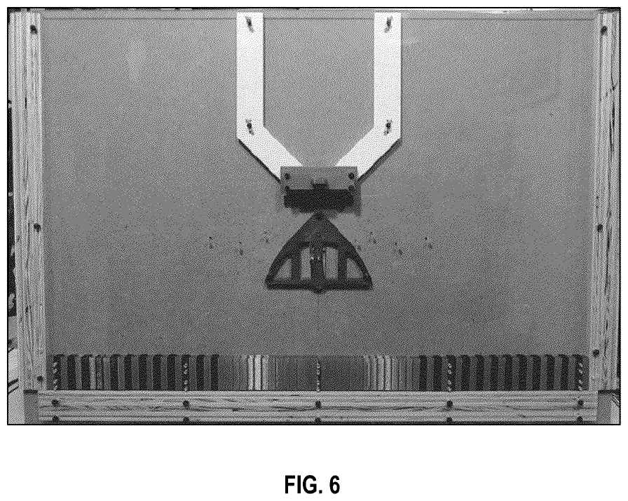

FIG. 6 illustrates an experimental system for separating a particulate feedstock according to the methods described herein. The system is similar to FIG. 1 and comprises: a hopper, a distribution chute, a fan and suitable pathways for causing air to flow out of the gas stream outlet, and bins.

A mixture of 95 wt % SiO₂ particulates and 5 wt % ilmenite particulates was prepared and processed in the experimental system of FIG. 6. The ilmenite traveled further from the distribution chute and concentrated in corresponding bins. Enrichment of the ilmenite was observed in bins that collected particulates and were laterally furthest from the distribution chute.

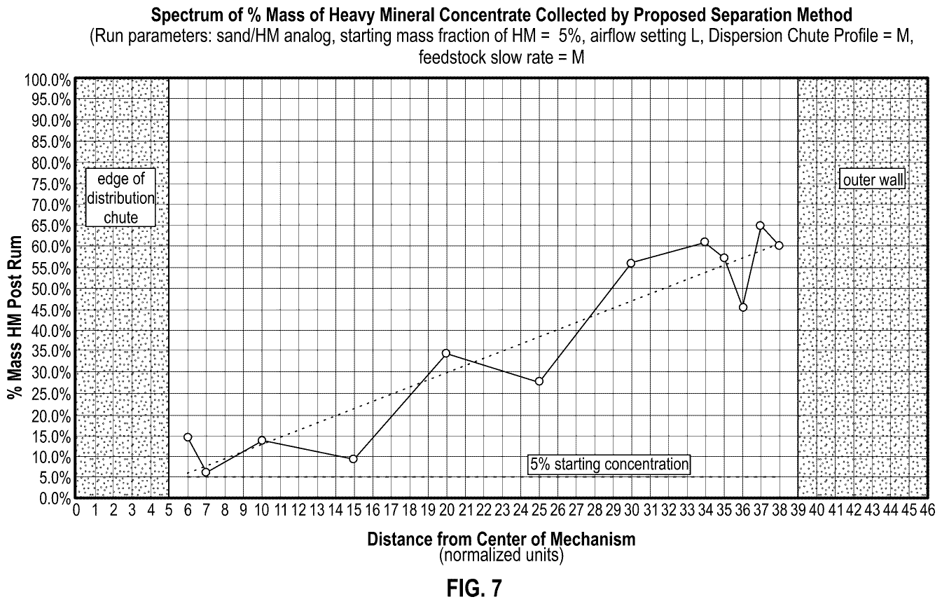

FIG. 7 illustrates a plot of the % mass of the particulate material collected in a bin as a function of the distance of the bin from the center of the distribution chute. This illustrates that the ilmenite concentration relative to original (5 wt %) increases as the bin distance from the distribution chute increases.

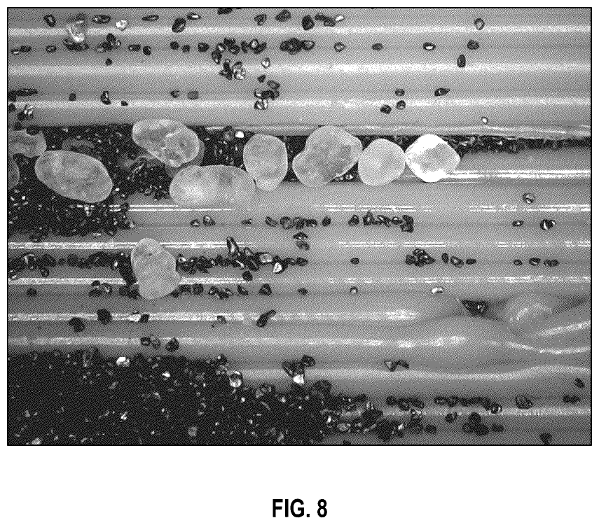

In a separate example, a surface texture (specifically corrugation) was applied to the distribution chute. As illustrated in FIG. 8 (a top-view photograph) the smaller particles (ilmenite) become confined in (or are slowed by) the valleys of the surface texture while the larger particles (silica) pass over the corrugation with less interference.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A method comprising:
flowing a layer of particulate feedstock over a distribution chute having an uneven surface texture, the particulate feedstock comprising first particulates and second particulates that differ by at least one property;
changing a momentum of individual particulates in the particulate feedstock with the uneven surface texture and/or a momentum changing feature while flowing over the distribution chute and/or with the momentum changing feature after leaving the distribution chute such that the first particulates and the second particulates, on average, travel different lateral distances from the distribution chute; and
collecting the particulate feedstock in a plurality of bins, wherein at least two of the bins are laterally spaced differently from the distribution chute.

2. The method of claim 1, wherein the layer has a thickness of about 10 mm or less.

3. The method of claim 1, wherein the at least one property comprises one or more of: specific gravity, size, shape, a magnetic property, and an electrical property.

4. The method of claim 1, wherein the first particulates are sand particulates and the second particulates are heavy mineral particulates.

5. The method of claim 4, wherein the sand particulates have an average diameter by weight of about 200 microns to about 1000 microns.

6. The method of claim 4, wherein the heavy mineral particulates comprise one or more minerals selected from the group consisting of: zircon, garnet, ilmenite, rutile, leucoxene, staurolite, celestine, monazite, magnetite, chromite, kyanite, hornblende, olivine, and sphene.

7. The method of claim 4, wherein the heavy mineral particulates comprise one or more minerals having a specific gravity of about 3.5 to about 7, wherein the sand particulates comprise one or more minerals having a specific gravity of about 2 to about 4, and wherein a cumulative specific gravity less of the sand particulates is less than a cumulative specific gravity of the heavy mineral particulates.

8. The method of claim 1, wherein the changing of the momentum comprises one or more of:
(a) applying an acoustic wave to the layer at an angle not parallel to a flow direction of the particulate feedstock leaving the distribution chute;
(b) applying a vibration to the distribution chute;
(c) applying a magnetic field to the distribution chute;
(d) applying an electrostatic charge to the distribution chute;
(e) applying a radiation pressure to the distribution chute;
(f) applying a rotational movement to the distribution chute; and
(g) applying a translational movement to the distribution chute.

9. The method of claim 1 further comprising:
drying the particulate feedstock to less than about 5 wt % water before the flowing of the particulate feedstock over the distribution chute.

10. The method of claim 1 further comprising:
using the particulate feedstock in one or more of the plurality of bins as a second particulate feedstock and repeating the method of claim 1 with the second particulate feedstock.

11. The method of claim 1, wherein changing the momentum of individual particulates with the uneven surface texture comprises impacting the individual particulates with corrugations of the uneven surface texture.

12. The method of claim 1, further comprising changing a size or position of an opening to at least one of the at least two bins with respect to the distribution chute.

13. The method of claim 12, wherein changing the size or position of the opening comprises moving walls of the at least two bins with respect to the distribution chute.

14. The method of claim 12, wherein changing the size or position of the opening is performed in response to an operational parameter detected by a sensor coupled to at least one of the at least two bins.

15. A system comprising:
a hopper capable of feeding a particulate feedstock to a distribution chute;
the distribution chute having an uneven surface texture capable of dispersing the particulate feedstock into a layer;
a momentum changing feature capable of changing a momentum of individual particulates in the particulate feedstock such that first and second particulates of the particulate feedstock travel, on average, different lateral distances from the distribution chute, wherein the first and second particulates have at least one different property; and
a plurality of adjustable bins capable of collecting the particulate feedstock therein, wherein at least two of the bins are laterally spaced differently from the distribution chute.

16. The system of claim 15 further comprising:
a dryer coupled to and/or upstream of the hopper; and
a sensor coupled to one or more of the plurality of bins.

17. The system of claim 15 further comprising:
a vehicle having the hopper, the distribution chute, and the plurality of bins mounted thereto.

18. The system of claim 15 wherein the uneven surface texture is corrugated to include valleys sized to confine the first particulates therein and peaks to permit the second particulates to pass over the distribution chute with less resistance than the first particulates.

19. The system of claim 15 wherein the uneven surface texture includes a plurality of discrete protrusions extending from surface of the distribution chute, wherein the plurality of discrete protrusions are unevenly spaced such that a spacing between the discrete protrusions decreases in a downward direction along the distribution chute.

20. The system of claim 15 wherein the plurality of bins includes a central bin disposed laterally inward of the distribution chute to for collecting backscattered particles.
